(19) United States
(12) Patent Application Publication
(10) Pub. No.: US 2026/0288196 A1
(43) Pub. Date: Sep. 24, 2026

(54) MULTIPLE-CHIP SYSTEM AND TIMING SYNCHRONIZATION METHOD

(71) Applicant: PHISON ELECTRONICS CORP., Miaoli (TW)

(72) Inventors: Jhe-Ru Guo, Miaoli County (TW); Ying-Chao Liao, Taoyuan City (TW); Po-Chih Ku, New Taipei City (TW)

(73) Assignee: PHISON ELECTRONICS CORP., Miaoli (TW)

(21) Appl. No.: 19/178,896

(22) Filed: Apr. 15, 2025

(30) Foreign Application Priority Data
Mar. 18, 2025 (TW) 114110029

(51) Int. Cl. G06F 1/12

(52) U.S. Cl. CPC G06F 1/12

(57) ABSTRACT

A multiple-chip system and a timing synchronization method. The multiple-chip system includes multiple chips. The chips includes a first chip and at least one second chip. The chips are connected to each other through a same input output bus (I/O bus). The timing synchronization method includes the following steps. Multiple detection patterns are respectively and sequentially transmitted to the I/O bus through the chips. First, the detection patterns are sequentially transmitted through each of the at least one second chip. Then, the detection patterns are transmitted through the first chip. A synchronization pattern is transmitted to the I/O bus through the first chip. The synchronization pattern is monitored from the I/O bus through each of the at least one second chip. A given function is performed through each of the chips based on the synchronization pattern.

### CROSS-REFERENCE TO RELATED APPLICATION

This application claims the priority benefit of Taiwan application serial no. 114110029, filed on Mar. 18, 2025. The entirety of the above-mentioned patent application is hereby incorporated by reference herein and made a part of this specification.

### BACKGROUND

### Technical Field

The disclosure relates to a timing synchronization technology, and in particular to a multiple-chip system and a timing synchronization method.

### Description of Related Art

With the development of technology, the demand for multiple-chip systems with high complexity and multiple functions is increasing. A general approach may be, for example, integrating multiple chips with various functions into a single chip, which would require high manufacturing costs. Or, multiple chips with various functions are connected based on a daisy chain structure. Specifically, each chip may be connected to a preceding chip and/or a succeeding chip through a bus, which would occupy more pins and limit synchronization performance due to hardware architecture.

### SUMMARY

The disclosure provides a multiple-chip system and a timing synchronization method to meet the timing synchronization requirement of the multiple-chip system, enhance flexibility for timing control, and reduce pin usage.

An exemplary embodiment of the disclosure provides a timing synchronization method for a multiple-chip system. The multiple-chip system includes multiple chips. The chips includes a first chip and at least one second chip. The chips are connected to each other through a same input output bus. The timing synchronization method includes the following steps. Multiple detection patterns are sequentially and respectively transmitted to the input output bus through the chips. The detection patterns are sequentially transmitted through each of the at least one second chip first. Then, the detection patterns are transmitted through the first chip. A synchronization pattern is transmitted to the input output bus through the first chip. The synchronization pattern is monitored from the input output bus through each of the at least one second chip. A given function is performed through each of the chips based on the synchronization pattern.

In an exemplary embodiment of the disclosure, the detection patterns are all different.

In an exemplary embodiment of the disclosure, the step of sequentially and respectively transmitting the detection patterns to the input output bus through the chips further includes the following steps. When a specific detection pattern is monitored from the input output bus through each of the chips, the detection pattern is transmitted to the input output bus through each of the chips. The specific detection pattern is the detection pattern transmitted through a preceding chip of each of the chips.

In an exemplary embodiment of the disclosure, the timing synchronization method further includes the following step. When each of the chips is powered on, a power-on signal is transmitted to the input output bus through each of the chips.

In an exemplary embodiment of the disclosure, the timing synchronization method further includes the following step. In response to one of the chips being abnormal, an error signal is transmitted to the input output bus through the abnormal one of the chips.

In an exemplary embodiment of the disclosure, the timing synchronization method further includes the following step. When each of the chips completes the given function, a standby signal is transmitted to the input output bus through each of the chips.

In an exemplary embodiment of the disclosure, the timing synchronization method further includes the following steps. A restart signal is received from the input output bus through each of the chips. The restart signal is for indicating that each of the chips restarts.

An exemplary embodiment of the disclosure further provides a multiple-chip system including multiple chips. The chips includes a first chip and at least one second chip. The chips are connected to each other through a same input output bus. The at least one second chip sequentially and respectively transmits at least one detection pattern to the input output bus. Each of the at least one second chip sequentially transmits the detection pattern first, and then the first chip transmits the detection pattern. The first chip transmits a synchronization pattern to the input output bus. Each of the second chips monitors the synchronization pattern from the input output bus. Each of the chips performs a given function based on the synchronization pattern.

In an exemplary embodiment of the disclosure, when a specific detection pattern is monitored from the input output bus through each of the chips, each of the chips transmits the detection pattern to the input output bus. The specific detection pattern is the detection pattern transmitted through a preceding chip of each of the chips.

In an exemplary embodiment of the disclosure, when each of the chips is powered on, each of the chips transmits a power-on signal to the input output bus.

In an exemplary embodiment of the disclosure, in response to one of the chips being abnormal, the abnormal one of the chips transmits an error signal to the input output bus.

In an exemplary embodiment of the disclosure, when each of the chips completes the given function, each of the chips transmits a standby signal to the input output bus.

In an exemplary embodiment of the disclosure, each of the chips receives a restart signal from the input output bus. The restart signal is for indicating that each of the chips restarts.

Based on the above, the multiple-chip system and the timing synchronization method of the disclosure may connect the chips through the input output bus, so as to avoid occupying pins of each of the chips. In response to that each of the chips has transmitted the detection pattern, the synchronization pattern is transmitted to the input output bus through a master chip, namely, the first chip, such that each of the chips may perform the given function based on the synchronization pattern, thereby meeting the timing synchronization requirement of the multiple-chip system.

### BRIEF DESCRIPTION OF THE DRAWINGS

FIG. 1 is a schematic diagram of a multiple-chip system according to an exemplary embodiment of the disclosure.

FIG. 2 is a timing diagram of an input output bus according to an exemplary embodiment of the disclosure.

FIG. 3 is a flowchart of a timing synchronization method according to an exemplary embodiment of the disclosure.

### DESCRIPTION OF THE EMBODIMENTS

Some exemplary embodiments of the disclosure will be described in detail below with reference to the drawings. For the reference numerals cited in the following description, when the same reference numerals appear in different drawings, the reference numerals will be regarded as referring to the same or similar elements. The exemplary embodiments are only a part of the disclosure and do not disclose all possible implementations of the disclosure. More specifically, the exemplary embodiments are merely examples in the claims of the disclosure.

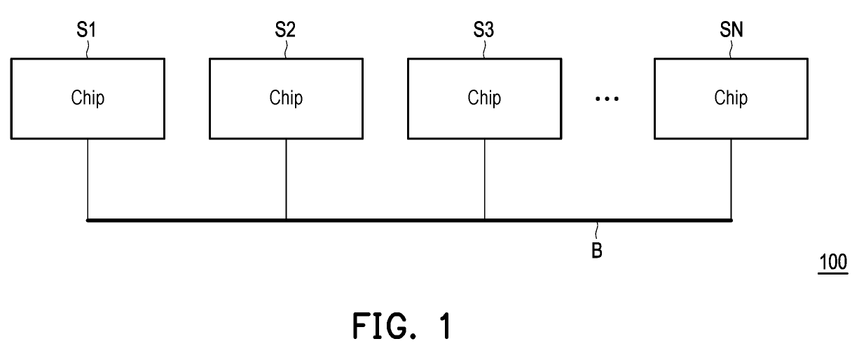

FIG. 1 is a schematic diagram of a multiple-chip system according to an exemplary embodiment of the disclosure. Referring to FIG. 1, a multiple-chip system 100 includes multiple chips S1 to SN. The chips S1 to SN are connected to each other through an input output bus (I/O Bus). The multiple-chip system 100 may be, for example, a system on chip (SoC), a power management integrated circuit (PMIC), a multiple-chip processor, a multiple-chip controller, or another system having multiple chips. The number of chips (that is, the value of N) may be designed as needed according to actual requirements, and the disclosure is not limited thereto.

The chips S1 to SN may be, for example, sub-processing units in the multiple-chip system 100. The chips S1 to SN may operate collaboratively to perform various operations. The chips S1 to SN may, for example, respectively include one or more processing cores. The chips S1 to SN may be, for example, integrated in a circuit board (or substrate). The chips S1 to SN may include, for example, circuits for digital, analog, or mixed signals. The chips S1 to SN may respectively include, for example, one or more general-purpose (or dedicated) processors, general-purpose or special-purpose microcontrollers, microprocessors, arithmetic logic units, complex programmable logic devices, field-programmable gate arrays, or other similar elements or combinations of the above elements. The chips S1 to SN may be, for example, low-dropout regulators (LDO), oscillators, timers, processors, controllers, memories, random access memories (RAM), read-only memories (ROM), flash memories, solid state drives (SSD), temperature sensors, and other elements.

The chips S1 to SN may respectively have multiple given functions, which include but are not limited to a voltage selection function, a voltage regulation function, a computation processing function, a temperature detection function, and/or an input output (IO) function used for transmitting data (or signals) with other chips or devices (for example, memory, controller, and/or interface), and other functions. In an exemplary embodiment, the chips S1 to SN are chips of the same type, and therefore the chips S1 to SN have the same multiple given functions. A voltage received through at least one general-purpose input output pin (General-Purpose IO, GPIO) of the chips S1 to SN may be used to determine whether the chips S1 to SN are respectively a master chip or a slave chip, and to determine the given function to be respectively performed by the chips S1 to SN.

One of the input output pins (I/O pins) of the chips S1 to SN may be connected to an input output bus B, so as to exchange data (or signals) through the input output bus B. It should be noted that the multiple-chip system 100 of the disclosure may connect the chips S1 to SN through a same input output bus B, so as to avoid occupying other pins of the chips S1 to SN.

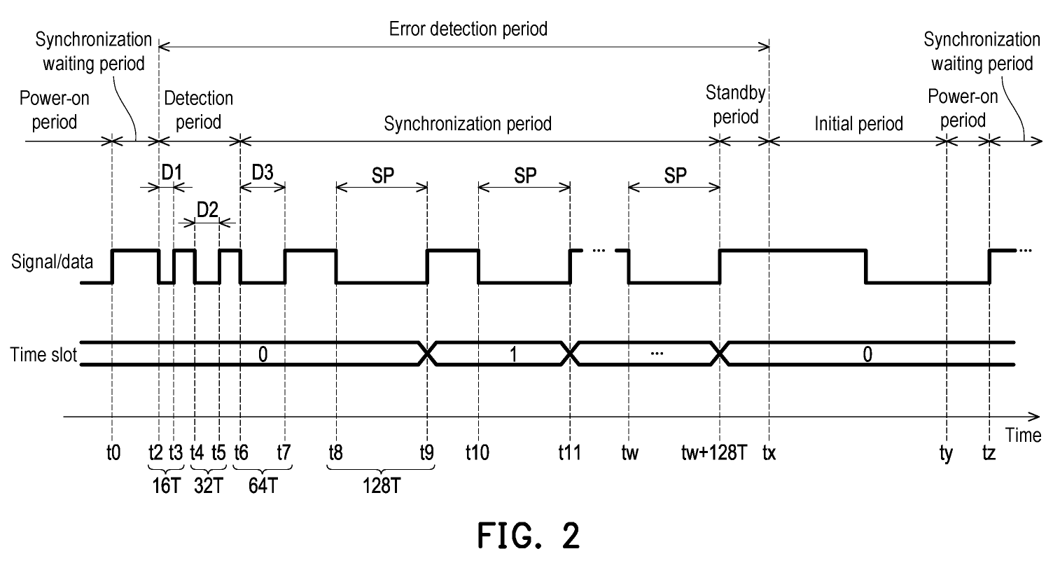

In order to synchronize the chips S1 to SN in the multiple-chip system, a timing synchronization method is provided to precisely synchronize operation timing of the chips S1 to SN. FIG. 2 is a timing diagram of an input output bus according to an exemplary embodiment of the disclosure. Referring to FIG. 2, assuming that N is 3, that is, the multiple-chip system 100 includes three chips S1 to S3, where the chip S1 and the chip S2 are slave chips (also referred to as second chips), and the chip S3 is a master chip (also referred to as a first chip). That is, a general-purpose input output pin of the chip S3 may receive a voltage used to determine that the chip S3 is a master chip and the given function to be performed by the chip S3. A general-purpose input output pin of the chip S1 may receive a voltage used to determine that the chip S1 is a slave chip and to perform, by the chip S1, the given function. Likewise, a general-purpose input output pin of the chip S2 may receive a voltage used to determine that the chip S2 is a slave chip and to perform, by the chip S2, the given function.

The chips S1 to S3 may transmit signals (or data) to each other through the input output bus B. Alternatively, the chips S1 to S3 may continuously monitor the signals (or data) transmitted through the input output bus B.

During a power-on period, when a chip (for example, the chip S1) is powered on, the chip S1 may transmit a power-on signal to the input output bus B. At a time point t0, the chips S1 to S3 have all completed power-on (that is, the chips S1 to S3 have all transmitted power-on signals to the input output bus B). At this time, a signal/data transmitted through the input output bus B rises from a first voltage level (for example, a logic value “0”) to a second voltage level (for example, a logic value “1”). Thereafter, the chips S1 to S3 may wait for a synchronization waiting period, and after the waiting period, the timing synchronization operation of the chips S1 to S3 is started.

After the synchronization waiting period, the chip S1, the chip S2, and the chip S3 may sequentially and respectively transmit detection patterns D1 to D3 to the input output bus B. Specifically, after the slave chip S1 and the slave chip S2 sequentially transmit a detection pattern D1 and the detection pattern D2, the master chip S3 may subsequently transmit the detection pattern D3. In an exemplary embodiment, when a chip (for example, the chip S2) monitors a specific detection pattern from the input output bus B, the chip S2 may transmit the detection pattern D2 to the input output bus B. The specific detection pattern is the detection pattern D1 transmitted through a preceding chip of the chip S2 (that is, the chip S1). Similarly, when the chip S3 monitors the detection pattern D2 from the input output bus B, the chip S3 may transmit the detection pattern D3 to the input output bus B.

In an exemplary embodiment, the detection patterns D1 to D3 are all different. At a time point t2, the slave chip S1 may transmit the detection pattern D1 having a length of 16 unit times (that is, 16T) to the input output bus B. As shown in FIG. 2, the slave chip S1 may transmit the detection pattern D1 having a length of 16T and being at a first voltage level (that is, a logic value “0”) to the input output bus B. Thereafter, when the chip S2 monitors the detection pattern D1 from the input output bus B, at a time point t4, the chip S2 may transmit the detection pattern D2 having a length of 32T and being at a logic value “0” to the input output bus B. Next, when the chip S3 monitors the detection pattern D2 from the input output bus B, at a time point t6, the chip S3 may transmit the detection pattern D3 having a length of 64T and being at a logic value “0” to the input output bus B.

The content and length of the detection patterns D1 to D3 and a synchronization pattern SP may be designed as needed according to actual requirements, and the disclosure is not limited thereto. In addition, a time point t3 (or a time point t5) may be, for example, not equal to the time point t4 (or the time point t6). That is, a time difference may be present between the time point t3 and the time point t4 (or between the time point t5 and the time point t6), as shown in FIG. 2. Alternatively, the time point t3 (or the time point t5) may be, for example, equal to the time point t4 (or the time point t6).

Further, the period from the time point t2 to the time point t6 may be referred to as a detection period. The slave chips S1 and S2 may sequentially transmit the detection patterns D1 and D2 to the input output bus B to notify the master chip S3 to start synchronizing timing of the multiple-chip system 100. Thereafter, a synchronization period starts from the time point t6. The master chip S3 may transmit the detection pattern D3 to notify the slave chips S1 and S2 to prepare for monitoring the synchronization pattern SP from the input output bus B. In another exemplary embodiment, the detection patterns D1 to D3 are all the same. The chips S2 and S3 may transmit the detection patterns D2 and D3 based on the number of detection patterns received from the input output bus B.

Regarding the synchronization period (that is, from the time point t6 to a time point tw+128T as shown in FIG. 2), it may be designed by a user as needed according to actual requirements. Suppose the user has predesigned the number of synchronization patterns SP required for a single timing synchronization to be fifteen. After the master chip S3 finishes transmitting the fifteen synchronization patterns SP, the synchronization period then ends.

During the synchronization period, as shown in FIG. 2, the master chip S3 may continuously transmit the synchronization patterns SP to the input output bus B. At this time, the master chip S3 may count the number of times the synchronization patterns SP have been transmitted. The time slots in FIG. 2 may be used to reflect the number of synchronization patterns SP transmitted by the master chip S3. For example, after the master chip S3 finishes transmitting a first synchronization pattern SP, at a time point t9, a first time slot 0 enters a second time slot 1.

During the synchronization period, the slave chips S1 and S2 may monitor the synchronization patterns SP from the input output bus B. Thereafter, the chips S1 to S3 may perform a given function at a specific time point based on the synchronization patterns SP. Specifically, each of the chips S1 to S3 needs to perform one or more given functions, and each given function needs to be performed at a specific time point. Further, the given functions to be performed by the chips S1 to S3 may be related, and therefore the chips S1 to S3 need to determine the time points (that is, specific time points) to perform the given functions based on the synchronization patterns SP during the synchronization period, so as to successfully perform all the given functions that need to be performed by the chips S1 to S3, and effectively reduce the occurrence rate of errors.

When a chip (for example, the chip S1) completes a given function, the chip S1 may transmit a standby signal to the input output bus B. In an exemplary embodiment, after the master chip S3 completes a given function and monitors standby signals of the slave chips S1 and S2 from the input output bus B, the master chip S3 may indicate that the multiple-chip system 100 enters a standby period. In an exemplary embodiment, the given functions of the chips S1 to S3 are all completed before a time point tw+128T. For example, the given functions of the chips S1 to S3 are all completed within fifteen synchronization patterns SP. Therefore, after the fifteen synchronization patterns SP are transmitted, the master chip S3 may indicate that the multiple-chip system 100 enters the standby period. At this time, the time slots in FIG. 2 may return from a fourteenth time slot 14 to a first time slot 0.

Thereafter, at a time point tx, the chips S1 to S3 may receive a restart signal from the input output bus B to enter an initial period. The restart signal is used to indicate that the chips S1 to S3 restart. For example, a user may transmit a restart signal (or instruction) to the multiple-chip system 100 through an external device (not shown) to indicate that the multiple-chip system 100 restarts. Alternatively, during the standby period, after a period of time has passed, at the time point tx, the multiple-chip system 100 may automatically enter the initial period.

During the initial period, the chips S1 to S3 may perform initialization. After the initialization is completed, at a time point ty, power-on is restarted (that is, the power-on period is entered). When the chips S1 to S3 have all completed power-on, the chips S1 to S3 enter the synchronization waiting period at a time point tz in preparation for another timing synchronization operation of the chips S1 to S3.

It should be noted that the period from the time point t2 to the time point tx may be referred to as an error detection period. That is, the detection period, the synchronization period, and the standby period may be collectively referred to as the error detection period. During the error detection period, if one of the chips S1 to S3 (for example, the chip S1) is abnormal, the abnormal chip S1 may transmit an error signal to the input output bus B to stop operation of the multiple-chip system 100 (or the chips S1 to S3). For example, the abnormal chip S1 may transmit an error signal having a length of X unit times (T) and being at a logic value “0” (or a logic value “1”) to the input output bus B, wherein the length of the error signal (that is, XT) may be, for example, greater than the length of the synchronization pattern SP (that is, 128T). Accordingly, a self-maintenance operation may be performed on the abnormal chip S1 by the multiple-chip system 100, or a maintenance operation may be performed on the multiple-chip system 100 (the abnormal chip S1) by an external device (not shown).

It is worth mentioning that if the chip S1 (or the chip S2, the chip S3) encounters an error while transmitting the detection pattern D1 (or the detection pattern D2, the detection pattern D3), since the detection patterns D1 to D3 are all different, if a chip (for example, the chip S1) is abnormal while transmitting a detection pattern, the multiple-chip system 100 (or the above-mentioned external device) may determine that the abnormal chip is the chip S1 in response to not receiving the detection pattern D1, thereby reducing the time for error detection and improving maintenance efficiency.

According to the above, in the multiple-chip system 100 of the disclosure, in response to the chips S1 to S3 having all transmitted the detection patterns D1 to D3, the synchronization pattern SP is transmitted to the input output bus B through the master chip S1, such that the chips S1 to S3 may all perform a given function based on the synchronization pattern SP to complete timing synchronization of the multiple-chip system 100.

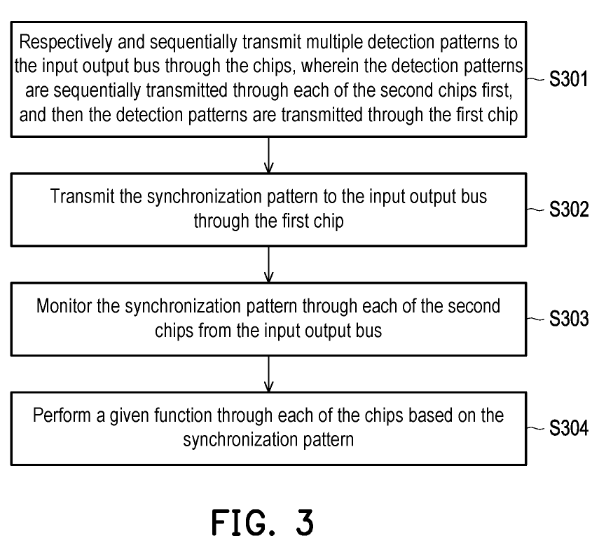

FIG. 3 is a flowchart of a timing synchronization method according to an exemplary embodiment of the disclosure. Referring to FIG. 3, in step S301, multiple detection patterns are sequentially and respectively transmitted to an input output bus through multiple chips, wherein the detection patterns are sequentially transmitted through each of the second chips first, and then transmitted through a first chip. In step S302, a synchronization pattern is transmitted to the input output bus through the first chip. In step S303, the synchronization pattern is monitored from the input output bus through each of the second chips. In step S304, a given function is performed through each of the chips based on the synchronization pattern.

The steps in FIG. 3 have been described in detail above, and thus are not repeated here. It is worth noting that the steps in FIG. 3 may be implemented as multiple codes or circuits, and the disclosure is not limited thereto. In addition, the method in FIG. 3 may be used together with the above exemplary embodiments or used independently, and the disclosure is not limited thereto.

In summary, the multiple-chip system and the timing synchronization method provided in the exemplary embodiments of the disclosure may connect multiple chips through an input output bus, so as to avoid occupying pins of each of the chips. In response to each of the chips having transmitted a detection pattern, a synchronization pattern is transmitted through a master chip, such that the slave chips may monitor the synchronization pattern from the input output bus and perform a given function based on the synchronization pattern, thereby meeting the timing synchronization requirement of the multiple-chip system. In addition, the multiple-chip system and the timing synchronization method provided in the embodiments of the disclosure may further reduce error detection time by designing different detection patterns for each chip, thereby improving maintenance efficiency.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. A timing synchronization method for a multiple-chip system, wherein the multiple-chip system comprises a plurality of chips, the plurality of chips comprises a first chip and at least one second chip, and the plurality of chips are connected to each other through a same input output bus, the timing synchronization method comprising:
sequentially and respectively transmitting a plurality of detection patterns to the input output bus through the plurality of chips, wherein the plurality of detection patterns are sequentially transmitted through each of the at least one second chip first, and then the plurality of detection patterns are transmitted through the first chip;
transmitting a synchronization pattern to the input output bus through the first chip;
monitoring the synchronization pattern from the input output bus through each of the at least one second chip; and
performing a given function through each of the plurality of chips based on the synchronization pattern.

2. The timing synchronization method according to claim 1, wherein the plurality of detection patterns are all different.

3. The timing synchronization method according to claim 2, wherein sequentially and respectively transmitting the plurality of detection patterns to the input output bus through the plurality of chips further comprises:
when a specific detection pattern is monitored from the input output bus through each of the plurality of chips, transmitting the detection pattern to the input output bus through each of the plurality of chips, wherein the specific detection pattern is the detection pattern transmitted through a preceding chip of each of the plurality of chips.

4. The timing synchronization method according to claim 1, further comprising:
when each of the plurality of chips is powered on, transmitting a power-on signal to the input output bus through each of the plurality of chips.

5. The timing synchronization method according to claim 1, further comprising:
in response to one of the plurality of chips being abnormal, transmitting an error signal to the input output bus through the abnormal one of the plurality of chips.

6. The timing synchronization method according to claim 1, further comprising:
when each of the plurality of chips completes the given function, transmitting a standby signal to the input output bus through each of the plurality of chips.

7. The timing synchronization method according to claim 1, further comprising:
receiving a restart signal from the input output bus through each of the plurality of chips, wherein the restart signal is for indicating that each of the plurality of chips restarts.

8. A multiple-chip system, comprising:
a plurality of chips, connected to each other through a same input output bus, the plurality of chips comprising a first chip and at least one second chip,
wherein the at least one second chip sequentially and respectively transmits at least one detection pattern to the input output bus, each of the at least one second chip sequentially transmits the detection pattern first, and then the first chip transmits the detection pattern, wherein
the first chip transmits a synchronization pattern to the input output bus,
each of the plurality of second chips monitors the synchronization pattern from the input output bus, and
each of the plurality of chips performs a given function based on the synchronization pattern.

9. The multiple-chip system according to claim 8, wherein the plurality of detection patterns are all different.

10. The multiple-chip system according to claim 9, wherein when each of the plurality of chips monitors a specific detection pattern from the input output bus, each of the plurality of chips transmits the detection pattern to the input output bus, wherein the specific detection pattern is the detection pattern transmitted through a preceding chip of each of the plurality of chips.

11. The multiple-chip system according to claim 8, wherein when each of the plurality of chips is powered on, each of the plurality of chips transmits a power-on signal to the input output bus.

12. The multiple-chip system according to claim 8, wherein in response to one of the plurality of chips being abnormal, the abnormal one of the plurality of chips transmits an error signal to the input output bus.

13. The multiple-chip system according to claim 8, wherein when each of the plurality of chips completes the given function, each of the plurality of chips transmits a standby signal to the input output bus.

14. The multiple-chip system according to claim 8, wherein each of the plurality of chips receives a restart signal from the input output bus, wherein the restart signal is for indicating that each of the plurality of chips restarts.
